(19) United States
(12) Patent Application Publication
(10) Pub. No.: US 2024/0093050 A1
(43) Pub. Date: Mar. 21, 2024

(54) COMPOSITIONS AND METHODS OF MAKING UV CURABLE SECURITY INKJET INKS

(71) Applicant: TROY GROUP, INC., Costa Mesa, CA (US)

(72) Inventors: Xiaorong Cai, Mount Pleasant, SC (US); Malissa Marie Wolfe, Bridgeport, OH (US); Kevin Heilman, Wheeling, WV (US); Michael R. Riley, Steubenville, OH (US)

(21) Appl. No.: 18/039,822

(22) PCT Filed: Nov. 15, 2021
(86) PCT No.: PCT/US21/59393

§ 371 Date: Jun. 1, 2023

Related U.S. Application Data
(60) Provisional application No. 63/114,327, filed on Nov. 16, 2020.

(51) Int. Cl. C09D 11/50; B41M 3/14; B41M 7/00; C09D 11/037; C09D 11/101; C09D 11/107; C09D 11/322; C09D 11/328; C09D 11/38; C09D 17/00

(52) U.S. Cl. CPC C09D 11/50; B41M 3/144; B41M 7/009; C09D 11/037; C09D 11/101; C09D 11/107; C09D 11/322; C09D 11/328; C09D 11/38; C09D 17/003

(57) ABSTRACT

A UV curable inkjet ink containing covert or overt ultraviolet or infrared reactive material. The ultraviolet or infrared reactive materials are processed in acrylate monomer or combination of acrylate monomer and acrylate oligomer media, along with photoinitiators and surfactants to produce an inkjet ink for printing on non-porous substrates such as plastic, glass, ceramic or metal with high adhesion, scratch and chemical resistance and providing a security feature responsive to ultraviolet or infrared radiation.

### CROSS REFERENCE TO RELATED APPLICATIONS

This application claims the benefit of U.S. provisional application No. 63/114,327 filed Nov. 16, 2020 for Composition and Methods of UV Curable Security Inkjet Inks, the entire disclosure which is hereby incorporated by reference.

### BACKGROUND OF THE INVENTION

### 1. Field of the Invention

The present invention relates to UV curable ink compositions and methods of making ink compositions having security features.

### 2. Description of Related Art

In the field of printing technology, digital printing is increasingly replacing analog printing systems, like offset and flexography, because of its flexibility in use and the variable data printing capabilities. UV curable inks are a preferred printing technology because it produces a high-quality color image that can be printed on non-porous substrates, such as plastics, glass, ceramic or metal. In addition, when printed on non-porous substrates, they present high adhesion, scratch resistance and chemical resistance. UV curable inks have important industrial applications for printing on textiles, labels and packaging, for example. These industrial uses are increasingly requiring printing inks that have security features when used on textiles, labels and packaging, for example. Although covert (colorless) and overt (colored) ultraviolet and infrared reactive inkjet inks are known to provide security features, these inkjet inks are aqueous-based or solvent-based. These security inkjet inks do not hold up when printed on non-porous substrates or on textiles, labels and packaging, like UV curable inks.

In spite of a significant need for an inkjet ink that has both the characteristics of a UV curable ink and provides security features like security inkjet inks, none has been heretofore discovered or produced.

The present invention provides an inkjet ink having the characteristics of a UV curable ink with UV or IR reactive security features.

### SUMMARY OF THE INVENTION

The inkjet inks of the present invention use UV or IR reactive materials processed in acrylate monomer or acrylate oligomer, or a combination of both media and then formulated as a UV curable inkjet ink. The UV reactive or fluorescent materials used can be colorless (covert) or one of a multiple of colors (overt) under ambient light. The UV curable security inkjet ink can be made by using UV fluorescent dyes or a UV fluorescent pigment dispersion. One embodiment of a UV curable security inkjet ink is made by dissolving a colorless (covert) UV fluorescent dye in acrylate monomers and an acrylate oligomer. The solution of UV dye and the acrylate monomers and oligomers is mixed with photoinitiators and other additives like surfactants, for example, to form a UV curable inkjet printing ink having the desired security features. The colorless UV fluorescent dyes can be organic or inorganic UV fluorescent invisible blue, red, green, orange or yellow dyes, for example. The amount of UV fluorescent material used may be from 0.1% by weight to 10% by weight of the ink composition. The preferred range is 0.2% by weight to 5% by weight. The acrylate monomer used is preferable a linear mono acrylate, for example. The acrylate oligomer can be acrylate, urethane acrylate, or polyester acrylate, for example. The photoinitiator used can be ethyl phenol phosphinate, for example. The preferred amount of photoinitiators is from 1% by weight to 20% by weight of the ink composition and preferably 3% by weight to 10% by weight of the ink composition. Overt and covert UV curable security inkjet inks may also be prepared by using a pigment dispersion which utilizes overt and covert UV reactive pigments or Infrared reactive pigments, dispersants and stabilizers mixed with acrylate monomers and other additives, like defoamers, for example. The dispersant is then mixed with acrylate monomers and acrylate oligomers along with additives such as photoinitiators and surfactants, for example. The mixture can be processed using a three-roll mill or a wet-media mill. The resulting pigment dispersion is formulated with photoinitiators and other additives like surfactants, along with acrylate monomers and acrylate oligomers to produce a desired UV curable security inkjet ink. The UV or IR pigment dispersion is preferably from 0.1% by weight to 5.0% by weight of the ink composition. The color pigment utilized in a dispersion is preferably present in the amount of 0.0% by weight to 8.0% by weight of the ink composition.

### DETAILED DESCRIPTION OF THE PREFERRED EMBODIMENTS

The UV curable, UV reactive or fluorescent security inks of the present invention can be either colorless or any color, under ambient light. The covert inks are prepared by dissolving colorless UV fluorescent dyes with acrylate monomers and oligomers and mixing the dye solution with photoinitiators and other additives to form a UV curable security inkjet printing ink with the desired security features.

The UV fluorescent invisible dyes used in the current invention can be organic and inorganic UV fluorescent invisible blue dyes, invisible red dyes, invisible green dyes, invisible orange dyes, or invisible yellow dyes, for example. The preferred amount of UV fluorescent invisible dye in the ink composition can be from 0.1 wt % to 10 wt %, and more preferably from 0.2 wt % to 5 wt %.

Acrylate monomers that can be used in the current invention are linear monoacrylate monomers, such as 2(2-ethoxyethoxy) ethyl acrylate, isodecyl acrylate, octyl/decyl acrylate, lauryl acrylate, tridecyl acrylate, caprolactone acrylate, diethylene glycol butyl ether acrylate; cyclic monofunctional monomers such as tetrahydrofurfuryl acrylate, isobornyl acrylate, cyclic trimethylolpropane formal acrylate, isophoryl acrylate; aromatic monofunctional monomers such as 2-phenooxyehtyl acrylate, ethoxylated (4) phenol acrylate, ethoxylated (4) nonyl phenol acrylate; difunctional acrylate monomers such as hexanediol diacrylate, tricyclodecane dimethanol diacrylate, dioxane glycol diacrylate, dipropylene glycol diacrylate, tripropylene glycol diacrylate, polyethylene glycoldiacrylate, ethoxylated bisphenol A diacrylate, propoxylated (2) neopentyl glycol diacrylate; trifunctional acrylate monomers such as trimethylolpropane triacrylate, propoxylated (3) trimethylolpropane triacrylate, propoxylated glycerol triacrylate, tris(2-hydroxylethyl)isocyanurate triacrylate; teranad higher functional monomers such as dipentaerythritol penta/hexa acrylate, alkoxylated pentaerythritol tetraacrylate, alkoxylated pentaerythritol tetraacrylate, di(trimethylol)propane tetraacrylate; as well as amine modified polyesters and synergists.

Acrylate oligomers that can be used in the present invention are epoxy acrylate, urethane acrylate, polyether acrylate and polyester acrylate.

Photoinitiators that can be used in the current invention are Ethyl (2,4,6-trimethylbenzoyl) phenyl phosphinate (SpeedCure TPO-L), 2,4,6-trimethylbenzoyldiphenylphosphine oxide (SpeedCure TPO), phosphine oxide (SpeedCure BPO), 2-Isopropylthioxanthone (SpeedCure 2-ITX), 2-hydroxy-2-methyl-1-phenylpropanone (SpeedCure 73), 2-benzyl-2-dimethylamino-1-(4-morpholinophenyl)-butanone-1, 2-dimethylamino-2-(4-methyl-benzyl)-1-(4-morpholin-4-yl-phenyl)-butan-1-one, 1-hydroxy-cyclohexyl-phenyl-ketone, 1-[4-(2-Hydroxyethoxyl)-phenyl]-2-hydroxy-2-methylpropanone.

A preferred amount of Photoinitiator that can be used in the ink formulations is from 1% to 20% and preferably from 3% to 10% of the total weight of the UV curable ink.

The overt UV reactive inks of the present invention can be prepared by dissolving colored UV fluorescent dyes with acrylate monomers and oligomers, and formulated by mixing the dye solution with (or without) color pigment dispersions, photoinitiators, and other additives to form the desired inkjet printing ink.

Another way of making overt UV fluorescent inks is to process a colored UV fluorescing pigment in an acrylate monomer media with polymer dispersant using a three-roll mill or wet media mill. The pigment dispersion is then formulated in acrylate/oligomer media with photoinitiators and other additives to form the desired inkjet printing ink.

The UV fluorescent dye or pigment dispersion is preferably from 0.1 wt. % to 5.0 wt. % of the ink composition. The color pigment is preferably presented in the amount of 0.0 wt. % to 8.0 wt. % of the ink composition.

Specific covert UV curable security inkjet inks having UV reactive features that have been formulated are now described.

TABLE 1
Covert UV Fluorescent Dye Ink Examples

| Ingredient | Function | Ink 1 | Ink 2 | Ink 3 |
|---|---|---|---|---|
| CY-B-2S | Invisible blue dye | 1.0% | | |
| LUPTIL | Invisible red dye | | 1.0% | |
| SC-19M | Invisible green dye | | | 1.0% |
| Ph(EO)A | Acrylate monomer | | 10.0% | 10.0% |
| TMCHA | Acrylate monomer | 26.0% | 26.0% | 26.0% |
| TBCH | Acrylate monomer | 26.0% | 28.5% | 27.3% |
| IBOA | Acrylate monomer | 31.3% | 20.0% | 20.0% |
| Genomer 3414 ™ | Acrylate oligomer | 8.0% | 8.0% | 8.0% |
| TPO-L | Photoinitiator | | 6.0% | |
| TPO | Photoinitiator | 6.0% | | 6.0% |
| ITX | Photoinitiator | 1.2% | | 1.2% |
| Tego Rad 2250 ™ | Surfactant | 0.5% | 0.5% | 0.5% |
| Total | | 100.0% | 100.0% | 100.0% |

Table 1 shows examples of using UV curable UV fluorescent colorless inks. CY-B-2S is a UV fluorescent invisible blue dye from Jinan Chenghao Technology Co., Ltd. Jinan, China. LUPTIL is a UV fluorescent invisible red dye from Luminochem kft, Hungary. SC-19M is an UV fluorescent green dye from Angstrom Technologies, Inc. Ph(EO)A is 2-Phenoxyethyl acrylate under the trade names of SR339 from Sartomer, Miramer M140 from Rahn, Photomer 4035 from IGM, or Laromer POEA from BASF. TMCHA is Trimethylcyclohexyl acrylate undertrade names of SR420 from Sartomer or Genomer 1120 fom Rahn. TBCH is 4-tert-Butylcyclohexyl acrylate under trade names of SR217 from Sartomer, Genomer 1119 from Rahn, or Laromer TBCH from BASF. IBOA is Isobornyl acrylate under trade names of SR506A from Sartomer, Genomer 1121Y from Rahn, Allnex IBOA from Allnex, or Photomer 4012 from IGM. Genomer 3414™ is an acrylate oligomer from Rahn. Tego Rad 2250™ is a surfactant from Evonik.

Ink 1, Ink 2, and Ink 3 of Table 1 were tested in an inkjet printing system with a KM1024i inkjet printhead from Konica Minolta Company. An FT200, 395 nm UV lamp from Phoseon Technology was built into the printing system to cure the ink on the printed substrates. The inks were printed directly on HDPE plastic, aluminum, and glass substrates and were cured immediately after printing. The print quality of these three example inks were good. The inks dried instantly, after being cured with the attached UV lamp and provided excellent adhesion to the tested substrates.

The printed images on the substrates were colorless, but presented strong UV fluorescent color under a UV light or black light.

Another method of producing covert UV fluorescent inks requires processing an invisible UV fluorescing pigment in acrylate monomer media with polymeric dispersants using a three-roll mill or wet media mill. The polymeric dispersion dissolves in the acrylate monomer. Then, UV fluorescent pigment is mixed with the polymeric monomer dispersion solution to a uniform mixture, by using a wet mill to grind the pigment particles in the mixture until the pigment particle size is reduced to under 200 nm. The pigment resulting dispersion is then formulated in acrylate/oligomer monomer with photoinitiators and other additives to form the desired UV curable security inkjet printing ink.

Suitable invisible UV fluorescent pigments can be any type of invisible UV fluorescent pigment. The amount of invisible UV fluorescent pigment used can be from 5 wt % to 50 wt % of the total weight of the pigment dispersion mixture, and preferably from 10 wt % to 40 wt % of the total weight of the pigment dispersion mixture.

Suitable polymeric dispersions can be Joncryl™ dispersions from BASF, Solsperse™ dispersions from Lubrizol, DisperBYK™, BYK™ and BYKJLT™ dispersions from BYK Chemie GmBh, Tego™ Dispers™ dispersions from Evonik, and Dispex™, EFKA™ dispersions form BASF.

The ratio of fluorescing pigment to polymeric dispersant in the pigment dispersion mixture can be from 1:2 to 15:1, and preferably from 1:1 to 10:1.

TABLE 2
Covert (colorless) UV Fluorescent pigment dispersion examples

| | | Disper- | Disper- | Disper- |
|---|---|---|---|---|
| Ingredient | Function | sion 1 | sion 2 | sion 3 |
| CY-R-2S | Invisible red pigment | 20.0% | | |
| SFP-1300 | Invisible gree pigment | | 20.0% | |
| SC-11 | Invisible blue pigment | | | 20.0% |
| Solsperse ™ | Dispersant | 5.0% | 5.0% | |
| 36000 | | | | |
| BYKJET ™ 9150 | Dispersant | | | 5.0% |
| Genorad ™ 16 | Stabilizer | 1.0% | 1.0% | 1.0% |
| DPGDA | Acrylate monomer | 53.4% | | 53.4% |
| SR9003B | Acrylate monomer | | 53.4% | |
| IBOA | Acrylate monomer | | 20.0% | |
| TMP(EO)3TA | Acrylate monomer | 20.0% | | 20.0% |
| BYK-088 | Defoamer | 0.6% | 0.6% | 0.6% |
| Total | | 100% | 100% | 100% |

Table 2 shows these examples of covert UV fluorescent pigment dispersions. CY-R-2S is an invisible UV fluorescent red pigment from Jinan Chenghao Technology Co., Ltd. Jinan, China. SEP-1300 is an invisible green pigment from Spectra Systems, Corp., SC-11 is an invisible blue pigment from Angstrom Technologies Company. Solsperse™ 36000 is a polymeric dispersant from Lubrizol, BYKJET™ 9150 is a polymeric dispersant from BYK Chemie GmBh, Genorad™ 16 is a polymerization inhibitor from Rahn USA Corp., DPGDA is Dipropyleneglycol diacrylate under the trade names of SR508™ from Sartomer, Miramer™ M222 from Rahn USA Corp., Photomer™ 4226 from IGM and Laromer™ DPGDA from BASF, SR9003B is propoxylated neopentyl glycol diarylate from Sartomer. TMP(EO)3TA is an acrylate monomer under the trade names of SR454 from Sartomer, and Miramer™ M3130 from Rahn USA Corp. BYK-088 is a deformer from BYK Chemie GmBh.

The formulations of the three pigment dispersions were well-mixed using an overhead mixer, and then transferred into a wet mill for grinding until the pigment size is reduced under 200 nm (average diameter). The wet mill can be a Netzsch MiniCer from Netzsch Premier Technologies. All three dispersions in Table 2 are stable and were used to formulate the UV curable security inkjet inks of the current invention.

TABLE 3
Covert (colorless) UV curable UV fluorescent Ink Examples

| Ingredient | Function | Ink 4 | Ink 5 | Ink 6 |
|---|---|---|---|---|
| Dispersion 1 | Security feature | 5.0% | | |
| Dispersion 2 | Security feature | | 5.0% | |
| Dispersion 3 | Security feature | | | 5.0% |
| Ph(EO)A | Monomer | 8.0% | 10.0% | 8.0% |
| TMCHA | Monomer | 25.0% | 24.2% | 25.0% |
| TBCH | Monomer | 26.3% | 26.3% | 26.3% |
| IBOA | Monomer | 20.0% | 20.0% | 20.0% |
| Polyester/Polyether | Oligomer | 8.0% | 8.0% | 8.0% |
| Acrylate | | | | |
| TPO-L | Photoinitiator | | 6.0% | |
| TPO | Photoinitiator | 6.0% | | 6.0% |
| ITX | Photoinitiator | 1.2% | | 1.2% |
| BYK 3500 | Surfactant | 0.5% | 0.5% | 0.5% |
| Total | | 100.0% | 100.0% | 100.0% |

Table 3 shows three examples of Colorless UV curable UV fluorescent pigment inks using the fluorescent pigment dispersion from Table 2. The preferred amount of UV fluorescent pigment in the ink can be from 0.1 wt % to 10 wt % (weigh percentage of dry pigment) of the ink composition and preferably from 0.2 wt % to 5 wt % of the ink composition.

BYK™ 3500 in Table 3 is a surfactant from BYK Chemie GmBh.

Inks 4, Ink 5, and Ink 6 of Table 3 were tested in an inkjet printing system with a KM1024i inkjet printhead from Konica Minolta Company and ST200 395 nm UV lamp from Phoseon Technology. The inks were printed directly on HDPE plastic, aluminum, and glass substrates and were cured immediately after printing. The print quality for all three inks was good. The inks dried instantly after being cured with an attached UV lamp and had excellent adhesion to the tested substrates.

The printed images on the substrates were colorless but present strong UV fluorescent color under a UV light or black light.

Overt or colored UV curable UV fluorescent security inks can be prepared by dissolving colored UV fluorescent dyes in the acrylate monomers or acrylate oligomers and then mixing the dye solution with photoinitiators and other additives to form the desired UV curable security inkjet printing ink.

The colored UV fluorescent dyes used in the current invention can be organic or inorganic UV fluorescent color dyes. The preferred amount of UV fluorescent dye in the ink composition can be from 0.1 wt % to 10 wt %, and more preferably from 0.2 wt % to 8 wt %.

Another method of preparing colored UV fluorescent security inks in the current invention is to mix invisible UV fluorescent dye or invisible UV fluorescent pigment dispersions prepared as described above, with commercially available colored pigment dispersions in acrylate monomer and acrylate oligomer media. Photoinitiators and other ink property modifiers (additives) are added to form a colored UV fluorescent security ink.

Commercially available pigment dispersions can be used to make the colored organic pigment dispersions in acrylate monomer or organic solvent media.

The preferred amount of UV fluorescent materials, dye or pigment used can be from 0.1 wt % to 10 wt %, and preferably from 0.2 wt % to 5.0 wt %.

The preferred amount of colored pigment used can be from 0.5 wt % to 15 wt %, and preferably from 1% to 10%.

TABLE 4
Colored UV Curable UV Fluorescent Ink Examples

| Ingredient | Function | Ink 7 | Ink 8 | Ink 9 | Ink 10 | Ink 11 | Ink 12 | Ink 13 | Ink 14 |
|---|---|---|---|---|---|---|---|---|---|
| CY-B-2S | Security feature | 1.0% | 1.0% | 1.0% | 1.0% | | | | |
| Dispersion 1 | Security feature | | | | | 5.0% | 5.0% | 5.0% | 5.0% |
| Jetspersew UV Blue 15:4 | Colorant | 9.3% | | | | 9.3% | | | |
| Jetsperse UV Red 122 | Colorant | | 13.2% | | | | 13.2% | | |
| Jetsperse UV Yellow 150 | Colorant | | | 12.5% | | | | 12.5% | |
| Jetsperse UV Black 7 | Colorant | | | | 8.6% | | | | 8.6% |
| TMCHA | Acrylate monomer | 24.0% | 22.0% | 22.5% | 23.0% | 21.0% | 20.0% | 20.0% | 21.0% |
| TBCH | Acrylate monomer | 24.7% | 23.0% | 23.0% | 24.4% | 23.0% | 21.5% | 22.0% | 23.7% |
| IBOA | Acrylate monomer | 26.0% | 25.8% | 26.0% | 28.0% | 26.0% | 24.6% | 24.8% | 26.0% |
| Genomer 3414 | Acrylate oligomer | 8.0% | 8.0% | 8.0% | 8.0% | 8.0% | 8.0% | 8.0% | 8.0% |
| TPO | Photoinitiator | 6.0% | 6.0% | 6.0% | 6.0% | 6.0% | 6.0% | 6.0% | 6.0% |
| ITX | Photoinitiator | 0.5% | 0.5% | 0.5% | 0.5% | 1.2% | 1.2% | 1.2% | 1.2% |
| Tego Rad 2250 | Surfactant | 0.5% | 0.5% | 0.5% | 0.5% | 0.5% | 0.5% | 0.5% | 0.5% |
| Total | | 100.0% | 100.0% | 100.0% | 100.0% | 100.0% | 100.0% | 100.0% | 100.0% |

Table 4 lists examples of eight colored UV curable UV fluorescent inks according to the present invention. The inks were tested in an inkjet printing system with KM1024i inkjet printhead from Konica Minolta Company and ST200 395 nm UV lamp from Phoseon Technology. The inks were printed directly on HDPE plastic, aluminum, and glass substrates and were cured immediately after printing. The print quality for each ink is good. The inks dried instantly after being cured with an attached UV lamp and provided excellent adhesion to the test substrates.

The individual color images printed on the substrates are cyan for Ink7 and Ink 11, magenta for Ink 8 and Ink 12, yellow for Ink 9 and Ink 13, and black for Ink 10 and Ink 14. The printed images with Ink 7, Ink 8, Ink 9, and Ink 10 showed UV fluorescent blue color under UV light or black light. The printed images with Ink 11, Ink 12, Ink 13, and Ink14 showed UV fluorescent red color under UV light or black light.

Another method for preparing colored UV fluorescent security inkjet inks can use a wet mill to process a mixed pigment containing invisible UV fluorescent pigment and organic color pigment. The processed mixed pigment dispersion is then formulated with acrylate monomers, acrylate oligomers, photoinitiators, and other ink property modifiers to form a colored UV fluorescent security ink.

The mixed pigment is dispersed in monomers/polymeric dispersant solution. The mixture is processed in a wet mill until the particle size of the pigment is reduced to under 200 nm to form a stable pigment dispersion. The total pigment to polymeric dispersant ratio is from 1:2 to 10:1. The amount of total pigments in the dispersion can be from 5 wt % to 50 wt %, and preferably from 10% to 30%

The ratio of invisible UV fluorescent pigment and colored organic pigment is from 1:1 to 1:10, and preferably from 1:2 to 1:8.

TABLE 5
Colored UV curable UV fluorescent pigment dispersion examples

| Ingredient | Function | Dispersion 4 | Dispersion 5 | Dispersion 6 | Dispersion 7 |
|---|---|---|---|---|---|
| CY-R-2S | Pigment | 6.0% | 4.0% | 5.0% | 4.0% |
| Pigment Blue 15:3 | Pigment | 15.0% | | | |
| Pigment Red 122 | Pigment | | 16.0% | | |
| Pigment Yellow 74 | Pigment | | | 15.0% | |
| Pigment Black 7 | Pigment | | | | 16.0% |
| Solsperse 36000 | Dispersant | 5.0% | 5.0% | 2.0% | |
| BYKJET-9150 | Dispersant | | | | 2.0% |
| Genorad 16 | Stabilizer | 1.0% | 1.0% | 1.0% | 1.0% |
| DPGDA | Acrylate monomer | 52.4% | | 56.4% | |
| SR9003B | Acrylate monomer | | 53.4% | | 56.4% |
| IBOA | Acrylate monomer | | 20.0% | | 20.0% |
| TMP(EO)3TA | Acrylate monomer | 20.0% | | 20.0% | |
| BYK-088 | Defoamer | 0.6% | 0.6% | 0.6% | 0.6% |
| Total | | 100% | 100% | 100% | 100% |

Table 5 lists the examples of colored UV curable UV fluorescent pigment dispersion formulations. The suitable invisible UV fluorescent pigments suitable for the current invention include, but are not limited to UV fluorescent invisible blue, UV fluorescent invisible red, UV fluorescent invisible green, UV fluorescent invisible yellow, UV fluorescent orange. The UV fluorescent pigment used in the example of Table 5 is CY-R-2S UV fluorescent invisible red pigment from Jinan Chenghao Technology Co., Ltd. Jinan, China. The color pigments suitable for the current invention include, but are not limited to any organic and inorganic color pigments. The pigments used in the about examples of FIG. 5 are C. I. pigment blue 15:3, C. I. pigment red 122, C. I. pigment yellow 74, and C. I. pigment black 7.

The polymeric dispersants used in the about examples are Solsperse™ 36000 from Lubrizol and BYKJLT™ 9150 from BYK Chemie GmBh. Other suitable polymeric dispersions in the current invention include, but are not limited to Joncryl™ dispersions from BASF, Solsperse™ dispersions from Lubrizol, DisperBYK™, BYK™ and BYKJLT™ dispersions from BYK Chemie GmBh, Tego™ Dispers™ dispersions from Evonik, Dispex™, EFKA™ dispersions from BASF.

The formulations in the about examples of FIG. 5 were mixed using an overhead mixer and then transferred into a wet mill for grinding until the pigment size was reduced to under 200 nm (average diameter). The wet mill used in the current invention can be Netzsch MiniCer from Netzsch Premier Technologies. All dispersions in the example are stable and were used for formulating UV curable inkjet inks of the current invention.

TABLE 6
Colored UV curable UV Fluorescent Pigment Ink Examples

| Ingredient | Function | Ink 15 | Ink 16 | Ink 17 | Ink 18 |
|---|---|---|---|---|---|
| Dispersion 4 | Security feature | 19% | | | |
| Dispersion 5 | Security feature | | 25% | | |
| Dispersion 6 | Colorant | | | 20% | |
| Dispersion 7 | Colorant | | | | 25% |
| Ph(EO)A | Acrylate monomer | 8.0% | | 8.0% | |
| TMCHA | Acrylate monomer | 19.0% | 20.0% | 18.0% | 20.0% |
| TBCH | Acrylate monomer | 21.3% | 21.3% | 21.3% | 21.3% |
| IBOA | Acrylate monomer | 17.0% | 18.0% | 17.0% | 18.0% |
| Genomer 3414 | Acrylate oligomer | 8.0% | 8.0% | 8.0% | 8.0% |
| TPO | Photoinitiator | 6.0% | 6.0% | 6.0% | 6.0% |
| ITX | Photoinitiator | 1.2% | 1.2% | 1.2% | 1.2% |
| Tego Rad 2250 | Surfactant | 0.5% | 0.5% | 0.5% | 0.5% |
| Total | | 100.0% | 100.0% | 100.0% | 100.0% |

Table 6 lists examples of colored (overt) UV curable UV fluorescent pigment inks. Ink 15, Ink 16, Ink 17, and Ink 18 were tested in an inkjet printing system with KM1024i inkjet printhead from Konica Minolta Company and ST200 395 nm UV lamp from Phoseon Technology. The inks were printed directly on HDPE plastic, aluminum, and glass substrates and were cured immediately after printing. The print quality of the inks was good. The inks dried instantly after being cured with an attached UV lamp and provided excellent adhesion properties to the testing substrates.

The individual color printed images on the substrates are cyan for Ink15, magenta for Ink 16, yellow for Ink 17, and black for Ink 18. All printed images with Ink 15, Ink 16, Ink 17, and Ink 18 showed UV fluorescent red color under UV light or black light.

The infrared reactive security inks in the current invention can be either colorless or any color under ambient light. The covert inks are prepared by dissolving colorless infrared reactive dyes into acrylate monomers and acrylate oligomers and further formulated by mixing the dye solution with photoinitiators and other additives to form an inkjet printing ink with security features.

The infrared reactive dyes used in the current invention are organic and inorganic infrared reactive dyes. These include, but are not limited to, infrared fluorescent, infrared absorbing, infrared reflecting, and upconverting materials.

The preferred amount of infrared reactive dye in the ink composition can be from 0.1 wt % to 20 wt %, and preferably from 0.5 wt % to 10 wt %.

Another method of producing covert infrared reactive inks is to process an infrared reactive pigment dispersion in acrylate monomer and acrylate oligomer media with polymeric dispersants using a three-roll mill or wet media mill. The polymeric dispersion dissolves in the monomer. It is then mixed with infrared reactive pigment to a uniform mixture. A wet mill is used to grind the pigment particles in the mixture until the pigment particle size is reduced to under 200 nm. The pigment dispersion is then formulated in acrylate monomer/oligomer media with photoinitiators and other additives to form an inkjet printing ink.

Suitable infrared reactive pigments can be any type of infrared reactive pigment, including infrared fluorescent, infrared absorbing, infrared reflecting, and upconverting materials.

The preferred amount of infrared reactive pigments can be from 1 wt % to 50 wt % of the total weight of the pigment dispersion mixture, and preferably from 10 wt % to 30 wt % of the total weight of the pigment dispersion mixture.

Polymeric dispersions suitable for use in the current invention can be Joncryl™ dispersions from BASF, Solsperse™ dispersions from Lubrizol, DisperBYK™, BYK™ and BYKJLT™ dispersions from BYK Chemie GmBh, Tego™ Dispers™ dispersions form Evonik, Dispex™, EFKA™ dispersions from BASF. A pigment to dispersion ratio in the dispersion mixture can be from 1:2 to 15:1, and preferably from 1:1 to 10:1.

The preferred amount of infrared reactive pigment in the ink can be from 0.1 wt % to 20 wt % of the ink composition, and preferably from 0.5 wt % to 10 wt % of the ink composition.

The printed images using UV curable infrared reactive inks of the current invention can be detected using an infrared camera, infrared laser beam, special infrared detecting devices, and other infrared detecting equipment and devices based on the function of the infrared reactive materials, such as infrared fluorescent, infrared absorbing, infrared reflecting, or upconverting materials, depending as well on the infrared reactive wavelength of the material.

TABLE 7
Covert Infrared Reactive Pigment Dispersion Example

| Ingredient | Function | Dispersion 8 | Dispersion 9 |
|---|---|---|---|
| RM18 | Pigment | 20.0% | 20.0% |
| Solsperse ™ 88000 | Dispersant | 5.0% | 5.0% |
| Genorad 16 | Stabilizer | 1.0% | 1.0% |
| DPGDA | Acrylate monomer | 53.4% | |
| SR9003B | Acrylate monomer | | 53.4% |
| IBOA | Acrylate monomer | | 20.0% |
| TMP(EO)3TA | Acrylate monomer | 20.0% | |
| BYK-088 | Defoamer | 0.6% | 0.6% |
| Total | | 100% | 100% |

Table 7 lists the examples of infrared reactive pigment dispersions. RM18 is an infrared reactive pigment from Stardust Materials. Solsperse™ 88000 is a polymeric dispersant from Lubrizol Corporation. The pigment to dispersant ratio in the examples of dispersion 8 and dispersion 9 is 4:1. The formulations in the about examples were mixed using an overhead mixer and then transferred into a wet mill for grinding until the pigment size was reduced under 200 nm (average diameter). The wet mill used in the current invention is Netzsch MiniCer from Netzsch Premier Technologies. All dispersions in the example are stable and are used for further formulating the UV curable inkjet inks in the current invention.

TABLE 8
Colorless (Covert) UV Curable Infrared Reactive Ink Examples

| Ingredient | Function | Ink 19 | Ink 20 |
|---|---|---|---|
| Dispersion 8 | Security feature | 25.0% | |
| Dispersion 9 | Security feature | | 25.0% |
| Ph(EO)A | Acrylate monomer | 8.0% | |
| TMCHA | Acrylate monomer | 16.3% | 21.0% |
| TBCH | Acrylate monomer | 20.0% | 23.5% |
| IBOA | Acrylate monomer | 15.0% | 16.0% |
| Genomer ™ 5271 | Acrylate oligomer | 8.0% | 8.0% |
| TPO-L | Photoinitiator | | 6.0% |
| TPO | Photoinitiator | 6.0% | |
| ITX | Photoinitiator | 1.2% | |
| BYK 3500 | Surfactant | 0.5% | 0.5% |
| Total | | 100.0% | 100.0% |

Table 8 lists the examples of UV curable infrared reactive inkjet ink formulations. Genomer™ 5271 is an acrylate oligomer from Rahn Group.

Ink 19 and Ink 20 were tested in an inkjet printing system with KM1024i inkjet printhead from Konica Minolta Company and ST200 395 nm UV lamp from Phoseon Technology. The inks were printed directly on HDPE plastic, aluminum, and glass substrates and were cured immediately after printing. The print quality of example inks was good. The inks dried instantly, being cured with an attached UV lamp and provided excellent adhesion properties to the test substrates. The printed images with Ink 19 and Ink 20 are colorless and can be detected using a special IR taggant detector from Stardust Materials.

Overt infrared reactive security inks are prepared by dissolving colored infrared reactive dyes in the acrylate monomers and oligomers and formulated by mixing the dye solution with photoinitiators and other additives to form an inkjet printing ink with security features.

The colored infrared reactive dyes used in the current invention are organic and inorganic infrared reactive color dyes that can be infrared fluorescent, infrared absorbing, infrared reflecting, and upconverting materials.

The preferred amount of infrared reactive dye in the ink compositions can be from 0.1 wt % to 10 wt %, and preferably from 0.2 wt % to 8 wt %.

Another method of preparing colored infrared reactive security inks according to the current invention is to mix infrared reactive dye or infrared reactive pigment dispersions prepared as described above with commercially available colored pigment dispersions in acrylate monomer and oligomer media. Then adding photoinitiators, and other ink property modifiers (additives) to form a colored infrared reactive security ink.

The commercially available color pigment dispersions that can be used in the current invention are any colored organic pigment dispersions in acrylate monomer or organic solvent media.

The amount of infrared reactive materials, dye or pigment, can be from 0.1 wt % to 10 wt %, and preferably from 0.2 wt % to 5.0 wt %.

The amount of colored pigment can be from 0.5 wt % to 15 wt %, and preferably from 1% to 10%.

Another method of preparing colored infrared reactive security inks use a wet mill to process a mixed pigment containing invisible Infrared reactive pigment and organic color pigment. The processed mixed pigment dispersion is then formulated with acrylate monomers, oligomers, photoinitiators, and other ink property modifiers to form a colored infrared reactive security ink.

The mixed pigment is dispersed in monomers/polymeric dispersant solution. The mixture is processed in a wet mill until the particle size of the pigment is reduced to under 200 nm. The total pigment to polymeric dispersant ratio can be from 2:1 to 10:1. The amount of total pigment in the dispersion can be from 5 wt % to 50 wt %, and preferably from 10% to 30%

The ratio of invisible Infrared reactive pigment and colored organic pigment is from 3:1 to 1:5, and preferably from 2:1 to 1:3.

TABLE 9
Overt Infrared Reactive Dispersion Examples

| Ingredient | Function | Dispersion 12 | Dispersion 13 | Dispersion 14 | Dispersion 15 |
|---|---|---|---|---|---|
| RM18 | Pigment | 18.0% | 15.0% | 16.0% | 15.0% |
| Pigment Blue 15:3 | Pigment | 13.0% | | | |
| Pigment Red 122 | Pigment | | 15.0% | | |
| Pigment Yellow 74 | Pigment | | | 14.0% | |
| Pigment Black 7 | Pigment | | | | 15.0% |
| Solsperse 36000 | Dispersant | 5.0% | 5.0% | 5.0% | 5.0% |
| BYKJET-9150 | Dispersant | | | | |
| Genorad 16 | Stabilizer | 1.0% | 1.0% | 1.0% | 1.0% |
| DPGDA | Acrylate monomer | 47.4% | | 48.4% | |
| SR9003B | Acrylate monomer | | 48.4% | | 48.4% |
| IBOA | Acrylate monomer | | 15.0% | | 15.0% |
| TMP(EO)3TA | Acrylate monomer | 15.0% | | 15.0% | |
| BYK-088 | Defoamer | 0.6% | 0.6% | 0.6% | 0.6% |
| Total | | 100% | 100% | 100% | 100% |

Table 9 shows the examples of infrared reactive pigment dispersions. RM18 is an infrared reactive pigment from Stardust Materials. Solsperse™ 36000 is a polymeric dispersant from Lubrizol Corporation. The pigment to dispersant ratio in the example of dispersions can be 6:1. The formulations in the examples were mixed using an overhead mixer and then transferred into a wet mill for grinding until the pigment size was reduced under 200 nm (average diameter). The wet mill used in the current invention can be Netzsch MiniCer from Netzsch Premier Technologies. All dispersions in Table 9 are stable and were used to further formulate the UV curable inkjet inks of the current invention.

TABLE 10
Colored UV Curable Infrared Reactive Inkjet Ink Examples

| Ingredient | Function | Ink 21 | Ink 22 | Ink 23 | Ink 24 |
|---|---|---|---|---|---|
| Dispersion 12 | Security feature with color | 25% | | | |
| Dispersion 13 | Security feature with color | | 25% | | |
| Dispersion 14 | Security feature with color | | | 25% | |
| Dispersion 15 | Security feature with color | | | | 25% |
| Ph(EO)A | Acrylate monomer | 12.0% | | 8.0% | |
| TMCHA | Acrylate monomer | 23.0% | 20.0% | 16.0% | 20.0% |
| TBCH | Acrylate monomer | 24.3% | 21.3% | 20.3% | 21.3% |
| IBOA | Acrylate monomer | | 18.0% | 15.0% | 18.0% |
| Genomer 3414 | Acrylate oligomer | 8.0% | 8.0% | 8.0% | 8.0% |
| TPO | Photoinitiator | 6.0% | 6.0% | 6.0% | 6.0% |
| ITX | Photoinitiator | 1.2% | 1.2% | 1.2% | 1.2% |
| Tego Rad 2250 | Surfactant | 0.5% | 0.5% | 0.5% | 0.5% |
| Total | | 100.0% | 100.0% | 100.0% | 100.0% |

Table 10 shows examples of UV curable infrared reactive inkjet inks. Ink 21, Ink 22, Ink 23, and Ink 24 were tested in an inkjet printing system with KM1024i inkjet printhead from Konica Minolta Company and ST200 395 nm UV lamp from Phoseon Technology. The inks were printed directly on HDPE plastic, aluminum, and glass substrates and were cured immediately after printing. The print quality of all the inks was good. The inks dried instantly upon being cured with an attached UV lamp and provided excellent adhesion properties to the test substrates. The printed images with Ink 21, Ink 22, Ink 23, and Ink 24 presented the original pigment color, i.e., cyan, magenta, yellow and black colors. The printed images can be detected using a special IR taggant detector from Stardust Materials.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A UV curable security inkjet ink composition comprising:
a covert UV fluorescent dye;
one or more acrylate monomers;
one or more acrylate oligomers; and
photoinitiators,
wherein the viscosity of the inkjet ink composition is from 5 centipoise (cps) to 20 centipoise (cps).

2. The security inkjet ink composition of claim 1 wherein the covert fluorescent dye may fluoresce in any one of a multiple of colors when exposed to ultraviolet radiation.

3. The security inkjet ink composition of claim 1 wherein the covert fluorescent dye is from 0.1% by weight to 5% by weight of the ink composition.

4. The security inkjet ink composition of claim 1 further comprising:
a colored organic pigment dispersion.

5. The security ink composition of claim 4 wherein the colored organic pigment dispersion is from 1% dry weight to 10% dry weight of the ink composition.

6. A UV curable security inkjet ink composition comprising:
a covert UV fluorescent pigment dispersion;
one or more acrylate monomers;
one or more acrylate oligomers; and
photoinitiators.

7. The security inkjet ink composition of claim 6 wherein the UV fluorescent pigment dispersion is from 0.1% by dry weight to 5% by dry weight of the ink composition.

8. The security ink composition of claim 6 further comprising:
a colored organic pigment dispersion; and
wherein the viscosity of the inkjet ink composition is from 5 cps to 20 cps.

9. The security ink composition of claim 8 wherein the colored organic pigment dispersion is from 1% dry weight to 10% dry weight of the ink composition.

10. A UV curable security inkjet ink composition comprising:
an infrared reactive dye;
one or more acrylate monomers;
one or more acrylate oligomers; and
at least one photoinitiator.

11. The security inkjet ink of claim 10 wherein the infrared reactive dye is one of infrared fluorescent, infrared absorbing, infrared reflecting and infrared unconverting.

12. The security inkjet ink of claim 10 wherein the infrared reactive dye is from 0.1% by weight to 10% by weight of the ink composition.

13. The security inkjet ink of claim 10 further comprising:
a colored organic pigment dispersion; and
wherein the viscosity of the inkjet ink composition is from 5 cps to 20 cps.

14. The security inkjet ink of claim 13 wherein the colored organic pigment dispersion is from 1% by dry weight to 10% by dry weight in the ink composition.

15. A UV curable security inkjet ink composition, comprising:
an infrared reactive pigment dispersion;
a colored organic pigment dispersion;
one or more acrylate monomers;
one acrylate oligomers; and
photoinitiators.

16. The security inkjet ink of claim 15 wherein the infrared reactive pigment is from 0.1% by dry weight to 5% by dry weight of the ink composition.

17. The security inkjet ink of claim 15 wherein the viscosity of the inkjet ink composition is from 5 cps to 20 cps.

18. The security inkjet ink of claim 15 wherein the infrared reactive pigment is from 0.1% dry eight to 5% dry weight of the ink composition.

19. A method of making a UV fluorescent pigment dispersion for use in a UV curable security inkjet ink, comprising:
mixing a covert UV fluorescent pigment with a polymer dispersant, a defoamer and one ore more acrylate monomers; and
grinding the mixture in a wet mill until the particle size in the mixture is below 200 nm.

20. The method of claim 19 wherein the fluorescent pigment in the mixture is from 10% by weight to 50% by weight of the mixture.

21. The method of claim 19 wherein the fluorescent pigment dispersion to polymer dispersion ratio is from 1:1 to 10:1 in the mixture.

22. A method of making an infrared reactive pigment dispersion for use in a UV curable security inkjet ink, comprising:
mixing an infrared reactive pigment with a polymer dispersant, a defoamer and one or more acrylate monomers; and
grinding the mixture in a wet mill until the particle size in the mixture is below 200 nm.

23. The method of claim 22 wherein the infrared reactive pigment in the mixture is from 10% by weight to 50% by weight of the mixture.

24. The method of claim 22 wherein the ratio of the infrared reactive pigment to the polymer dispersant in the mixture is from 1:1 to 10:1.
